(19) United States
(12) Patent Application Publication
(10) Pub. No.: US 2015/0086015 A1
(43) Pub. Date: Mar. 26, 2015

(54) Cryptographically Protected Redundant Data Packets

(71) Applicants: Rainer Falk, Poing (DE); Steffen Fries, Baldham (DE)

(72) Inventors: Rainer Falk, Poing (DE); Steffen Fries, Baldham (DE)

(21) Appl. No.: 14/402,012

(22) PCT Filed: Apr. 16, 2013
(86) PCT No.: PCT/EP2013/057908

§ 371 Date: Nov. 18, 2014

(30) Foreign Application Priority Data
May 25, 2012 (DE) 10 2012 208 836.9

(51) Int. Cl. H04L 9/30

(52) U.S. Cl. CPC H04L 9/30; H04L 2209/24
USPC 380/255

(57) ABSTRACT

The embodiments relate to methods for generating cryptographically protected redundant data packets. N redundant data packets are produced by N different generation units. The respective generation unit is allocated a unique identification. N cryptographically protected redundant data packets are generated by an individual cryptographic function from the N generated redundant data packets, the cryptographic function being parameterized for generating the respective cryptographically protected data packet by a cryptographic key and by the identification allocated to the corresponding generation unit. The cryptographic key may be used for a plurality of channels. The embodiments also relate to a computer program product and a device for generating cryptographically protected redundant data packets. The embodiments further relate to a communication node for generating and transmitting cryptographically protected redundant data packets and to an arrangement for a communication network having a plurality of said type of communication nodes.

### CROSS-REFERENCE TO RELATED APPLICATIONS

The present patent document is a §371 nationalization of PCT Application Serial Number PCT/EP2013/057908, filed Apr. 16, 2013, designating the United States, which is hereby incorporated by reference, and this patent document also claims the benefit of DE 10 2012 208 836.9, filed on May 25, 2012, which is also hereby incorporated by reference.

### TECHNICAL FIELD

The present embodiments relate to a method and an apparatus for producing cryptographically protected redundant data packets. By way of example, the apparatus is a communication node or a network node in a communication network. In addition, the embodiments relate to an arrangement for a communication network having a plurality of such communication nodes.

### BACKGROUND

The transmission of data packets between communication or network nodes may be cryptographically protected in order to protect the transmission from manipulations or tapping. To this end, a cryptographic key is used. For each data packet or data frame, this requires many conventional methods to determine a fresh initialization vector or nonce value so that the encryption may not be broken. In high availability or security critical systems, redundant computation architectures and/or redundant data transmissions are frequently used. For this, there is a need for repeated use of such an initialization vector or nonce value to be prevented in such high availability or security critical systems too.

The protected data transmission described above is used by sensor nodes for transmitting sensor or measurement data, for example. In this regard, FIG. 1 depicts a block diagram of an example of a conventional sensor node 1. The sensor node 1 in FIG. 1 has a control device 2, for example a CPU, a flash memory 3, a RAM store 4, a radio module 5 for data transmission, a power supply 6 for supplying power, and two connected sensors 8, 9 that are coupled to the sensor node 1 via an input/output module 7. Such a sensor node 1 may be used as a network node in an arrangement for producing and transmitting cryptographically protected redundant data packets.

By way of example, in this regard, FIG. 2 depicts a block diagram of an example of such a conventional arrangement for producing and transmitting cryptographically protected redundant data packets. The arrangement in FIG. 2 has two network nodes 10, 20 that are of identical design. For these reasons, only the network node 10 is discussed below for the sake of clarity. The network node 10 has a control device, for example a CPU 15, which has two production units 13, 14 for producing redundant data packets. The respective production unit 13, 14 is coupled to a communication interface 11, 12. The communication interface 11, 12 generates cryptographically protected redundant data packets that are in turn transmitted to the second network node 20 redundantly via two communication links 31, 32.

In addition, FIG. 3 depicts a block diagram of a second example of a conventional arrangement for producing and transmitting cryptographically protected redundant data packets. The example in FIG. 3 differs from the example in FIG. 2 in that the network node 10 in FIG. 3 has two control devices 15, 16 with a respective production unit 13, 14 and has only one communication interface 11 that uses the single key K for encryption.

In the example in FIG. 2, the data packets to be sent from the network node 10 to the network node 20 are encrypted by the first communication interface 11 by the key K and by the second communication interface 12 by the key K.

Such a data packet transmitted via the communication links 31, 32 may have a header, data (e.g., useful data) and a checksum. The header may contain an identification (ID) for the transmitting node (e.g., a MAC address), an identification (ID) for the receiver node (e.g., a MAC address), a counter value, a type of the frame (e.g., data frame), control command (e.g., acknowledge), a field for indexing the data field, and further flags (e.g., version), security enabled acknowledge (e.g., acknowledge requested). By way of example, such a data frame may be cryptographically protected using the CCM method (in this regard see IEEE 802.15.4-2006, for example). This cited method allows confidentiality, integrity or else both to be protected. In the case of redundant Ethernet protocols, specifically in the case of the parallel redundancy protocol, it is known practice to code a lane ID as a parameter into the header field (see IEC SC65C WG15, Parallel Redundancy Protocol, an IEC standard for a seamless redundancy method applicable to hard-real time industrial Ethernet, Prof. Dr. Hubert Kirrmann, ABB Corporate Research, Switzerland, 2011, March 21).

The aforementioned CCM method and other methods, e.g., CTR (Counter Mode) or GCM (Galois Counter Mode), involve the data packets being protected by using what is known as a nonce, which is used for calculating the cryptographic protection. In this context, the nonce may also be called an initialization vector. The nonce is a value that is different for each data packet that is protected using the same cryptographic key. If such a nonce value is used repeatedly, attacks against the data frame encryption become possible. If the same nonce value is used more than once for the WEP encryption of 802.11 WLAN, for example, an attacker may obtain the XOR for two plain-text messages from the tapped data frames.

It is therefore important to provide that each nonce value is used only once with the same cryptographic key and the cryptographic key is changed when the possible value range of the nonce is exhausted.

The transmitting node may construct a nonce and uses it together with a key in order to cryptographically protect a data packet. The receiver constructs the same nonce on the basis of information that the data packet contains in plain text, and possibly also on the basis of stored state information. The currentness of a nonce may be provided by the transmitter in different ways and checked by the receiver in different ways.

This may involve the use of a counter value in the nonce construction. In order to be able to check the currentness of a nonce, the receiver stores information about the last received counter value and subsequently accepts only nonces that have a counter value that is greater than the stored counter value. It is also known that a data packet does not have to be used to transmit the counter value completely (e.g., 32 bits), but rather may be used to transmit just a portion, e.g., the least significant 8 bits.

### SUMMARY AND DESCRIPTION

The scope of the present invention is defined solely by the appended claims and is not affected to any degree by the statements within this summary. The present embodiments may obviate one or more of the drawbacks or limitations in the related art.

Accordingly, it is an object of the present embodiments to provide improved production of cryptographically protected redundant data packets.

Accordingly, a method for producing cryptographically protected redundant data packets is proposed. A first act involves N redundant data packets being produced by N different production units. In this case, the respective production unit has an associated explicit identification. A second act involves N cryptographically protected redundant data packets being generated from the N produced redundant data packets by a single cryptographic function, wherein the cryptographic function for the generation of the respective cryptographically protected data packet is parameterized using a cryptographic key and the identification associated with the corresponding production unit.

The respective identification explicitly identifies a production channel that has the respective production unit. By way of example, for single redundant production of cryptographically protected data packets, there are two separate production channels with a respective production unit and a respective identification.

Since the generation of the respective cryptographically protected data packet involves the cryptographic function being parameterized not just using the cryptographic key but also using the respective identification function, the cryptographic key may be used for a plurality of production channels or channels. In particular, reuse of the same initialization vector or nonce value with the same cryptographic key is prevented in this case. This also avoids what are known as replay attacks.

Furthermore, when checking the cryptographically protected redundant data packets, the receiver may report a potential risk to a channel via a management interface when there is a repeated error on said channel. This information may be used as additional information for an intrusion detection system, for example. This provides that in the present case, it is possible to distinguish whether anticipated redundant transmission of a data packet is involved or replay of a tapped data packet.

By way of example, the identification may be called a production channel identification, channel identification, lane identification (e.g., lane ID) or redundancy channel identification information. By way of example, this identification may include the logical computer ID in the case of a multichannel computer (e.g., 0 and 1 in the case of a two-channel computer or 00, 01, 10 in the case of a three-channel computer).

In addition, the identification may include an interface identification or a direction of transmission for a ring topology or redundant data transmissions.

In one embodiment, the N cryptographically protected redundant data packets are generated from the N produced redundant data packets by the single cryptographic function and a single initialization vector, wherein the cryptographic function for the generation of the respective cryptographically protected data packet is parameterized using the cryptographic key and an initialization vector derived from the initialization vector by the identification associated with the corresponding production unit.

In this embodiment, the initialization vector is derived by the respective identification for the respective production channel. The use of derived initialization vectors for parameterizing the cryptographic function easily allows a single cryptographic key to be used for a plurality of production channels or channels.

In a further embodiment, the respective derived initialization vector is derived from the initialization vector by a first derivation function parameterized using the associated identification.

The first derivation function may also be called an initialization vector derivation function. An initialization vector derivation function may be implemented with little complexity, and therefore provides a simple and inexpensive option for providing derived initialization vectors.

In a further embodiment, the respective value of the derived initialization vector is formed from a concatenation of an address for a transmitter of the cryptographically protected redundant data packets, the identification associated with the corresponding production unit and a current counter value.

As stated above, the identification may be a lane ID, for example. In this case, the lane ID may be used as a parameter for nonce construction. An example of the formation of the nonce is accordingly:
N: =TAILane-IDICTR,
   where N denotes the nonce and is determined by a concatenation, that is to say linking together, of the respective bit sequences, the address of the transmitting node (TA, Transmitter Address), the lane ID, and the counter CTR. This is a simple and hence inexpensive solution to providing derived initialization vectors.

In a further embodiment, the N cryptographically protected redundant data packets are generated from the N produced redundant data packets by the single cryptographic function and a single initialization vector, wherein the cryptographic function for the generation of the respective cryptographically protected data packet is parameterized using a cryptographic key, which is derived from the cryptographic key by the identification associated with the corresponding production unit, and the initialization vector.

In this embodiment, the identification is used for key derivation. The use of derived keys for parameterizing the cryptographic function easily allows a single cryptographic key to be used for a plurality of production channels or channels.

In a further embodiment, the respective derived cryptographic key is derived from the cryptographic key by a second derivation function parameterized using the associated identification.

The second derivation function may also be called key derivation or a key derivation function. Suitable key derivation functions are HMAC-SHA1, AES-CCM and KDF1, for example. A key derivation function may be implemented with little complexity and therefore provides a simple and inexpensive option for providing derived keys.

If K denotes the cryptographic key, lane ID denotes the identification of the channel (e.g., lane) used, KDF denotes the key derivation, and LK denotes the derived key, for example, then it holds that:
LK: =KDF (K, Lane-ID).

The derived key LK is used to protect the data packets or data frames. The parameter of the lane ID then codes a piece of information concerning which lane or which channel is involved. By way of example, this may be a bit (e.g., 0 or 1), a number (e.g., 0000, 1111) or a code string (e.g., “Lane-0” or “Lane-1”, “Lane-Left”, “Lane-Right”). In addition, further derivation parameters may additionally be used for the key derivation as well, such as a network identification, e.g. network name, a gateway address, a Domain Name Server (DNS), or a Uniform Resource Locator (URL).

In a further embodiment, the N cryptographically protected redundant data packets are generated from the N produced redundant data packets by the single cryptographic function and a single initialization vector, wherein the cryptographic function for the generation of the respective cryptographically protected data packet is parameterized using a cryptographic key, which is derived from the cryptographic key by the identification associated with the corresponding production unit, and an initialization vector derived from the initialization vector by the identification associated with the corresponding production unit.

In this embodiment, the identification is advantageously used in duplicate, namely both for deriving the initialization vector and for key derivation.

In a further embodiment, the respective derived initialization vector is derived from the initialization vector by a first derivation function parameterized using the associated identification, and the respective derived cryptographic key is derived from the cryptographic key by a second derivation function parameterized using the associated identification.

In a further embodiment, the produced cryptographic data packets include encrypted data.

In a further embodiment, the produced cryptographic data packets include digital signatures. By way of example, digital signatures may be used to authenticate a sender of an electronic message.

In a further embodiment, the produced cryptographic data packets include digital certificates. These digital certificates each include a public key and a digital signature. Digital certificates make it possible to provide that the public key of a sender of an electronic message, for example, actually belongs to the indicated sender of the message.

In addition, a computer program product is proposed that prompts the performance of the method as explained above on a program-controlled device.

A computer program product may be provided or delivered in a network as a storage medium, such as a memory card, USB stick, CD-ROM, DVD, or else in the form of a downloadable file from a server, for example. This may be effected in a wireless communication network, for example, by the transmission of an appropriate file with the computer program product.

Furthermore, a data storage medium with a stored computer program having commands is proposed that prompts the performance of the method as explained above on a program-controlled device.

In addition, an apparatus for producing cryptographically protected redundant data packets is proposed. The apparatus has a number N of production units for producing N redundant data packets, wherein the respective production unit has an associated explicit identification. In addition, the apparatus has a number N of generation units for generating N cryptographically protected redundant data packets from the N produced redundant data packets by a single cryptographic function. In this case, the respective generation unit is configured to parameterize the cryptographic function for the generation of the respective cryptographically protected data packet using a cryptographic key and the identification associated with the corresponding production unit.

The respective unit, production unit, and generation unit may be implemented in hardware and/or else in software. In the case of a hardware implementation, the respective unit may be in the form of an apparatus or in the form of part of an apparatus, for example, in the form of a computer or in the form of a microprocessor. In the case of a software implementation, the respective unit may be in the form of a computer program product, in the form of a function, in the form of a routine, in the form of part of a program code, or in the form of an executable object.

In one development, the apparatus is in the form of a communication node in a communication network. The communication node has at least one control device, for example a Central Processing Unit (CPU), and at least one communication interface coupled to the communication network, for example an Network Interface Controller (NIC).

In a further development, the control device integrates the N production units and the communication interface the N generation units.

In a further development, the control device integrates the N production units and the N generation units.

Furthermore, an arrangement for a communication network is proposed that has a plurality of communication nodes. The communication nodes are coupled via the communication network. The respective communication node has an apparatus as described above for producing cryptographically protected redundant data packets.

The properties, features, and advantages that are described above and also the manner in which they are achieved will become clearer and more distinctly comprehensible in connection with the description of the exemplary embodiments below, which are explained in more detail in connection with the drawings. In this case, the communication node may also be called a network node. In addition, the communication node may also be in the form of a sensor node.

### BRIEF DESCRIPTION OF THE DRAWINGS

FIG. 1 depicts a block diagram of an example of a conventional sensor node.

FIG. 2 depicts a block diagram of a first example of a conventional arrangement for producing and transmitting cryptographically protected redundant data packets.

FIG. 3 depicts a block diagram of a second example of a conventional arrangement for producing and transmitting cryptographically protected redundant data packets.

FIG. 4 depicts a flowchart of a first exemplary embodiment of a method for producing cryptographically protected redundant data packets.

FIG. 5 depicts a block diagram of a cryptographic function for producing cryptographically protected redundant data packets as depicted in FIG. 4.

FIG. 6 depicts a flowchart of a second exemplary embodiment of a method for producing cryptographically protected redundant data packets.

FIG. 7 depicts a block diagram of a cryptographic function for producing cryptographically protected redundant data packets as depicted in FIG. 6.

FIG. 8 depicts a block diagram of a first exemplary embodiment of an arrangement for producing and transmitting cryptographically protected redundant data packets.

FIG. 9 depicts a flowchart of a third exemplary embodiment of a method for producing cryptographically protected redundant data packets.

FIG. 10 depicts a block diagram of a cryptographic function for producing cryptographically protected redundant data packets as depicted in FIG. 9.

FIG. 11 depicts a block diagram of a second exemplary embodiment of an arrangement for producing and transmitting cryptographically protected redundant data packets.

FIG. 12 depicts a block diagram of a third exemplary embodiment of an arrangement for producing and transmitting cryptographically protected redundant data packets.

FIG. 13 depicts a block diagram of a fourth exemplary embodiment of an arrangement for producing and transmitting cryptographically protected redundant data packets.

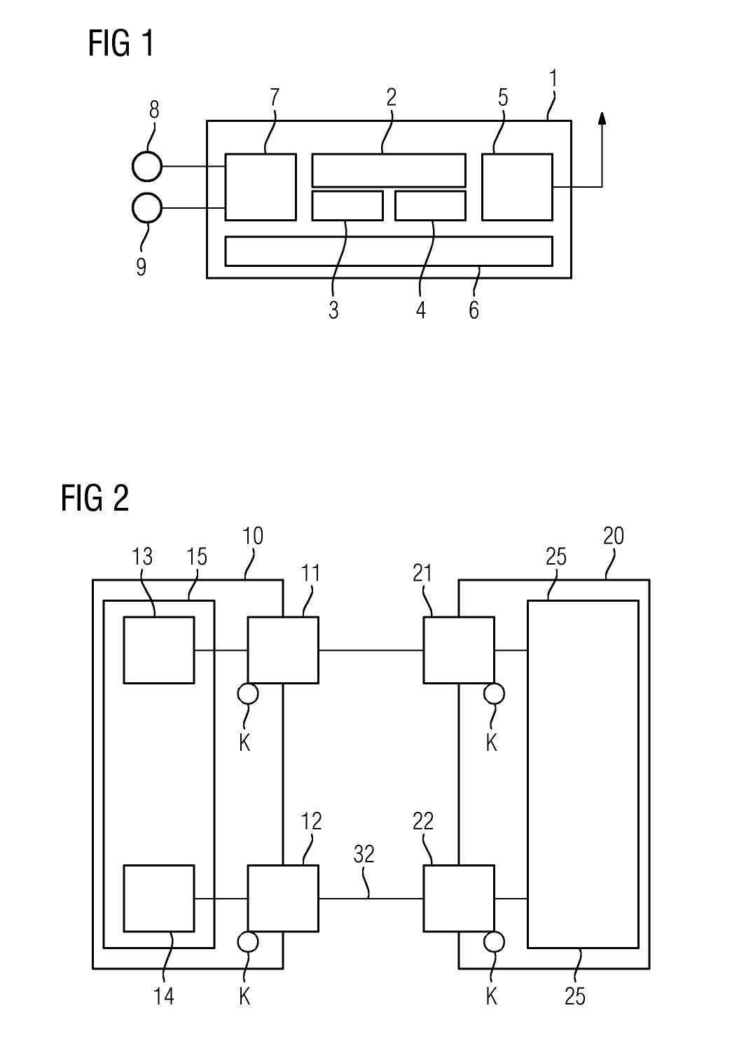

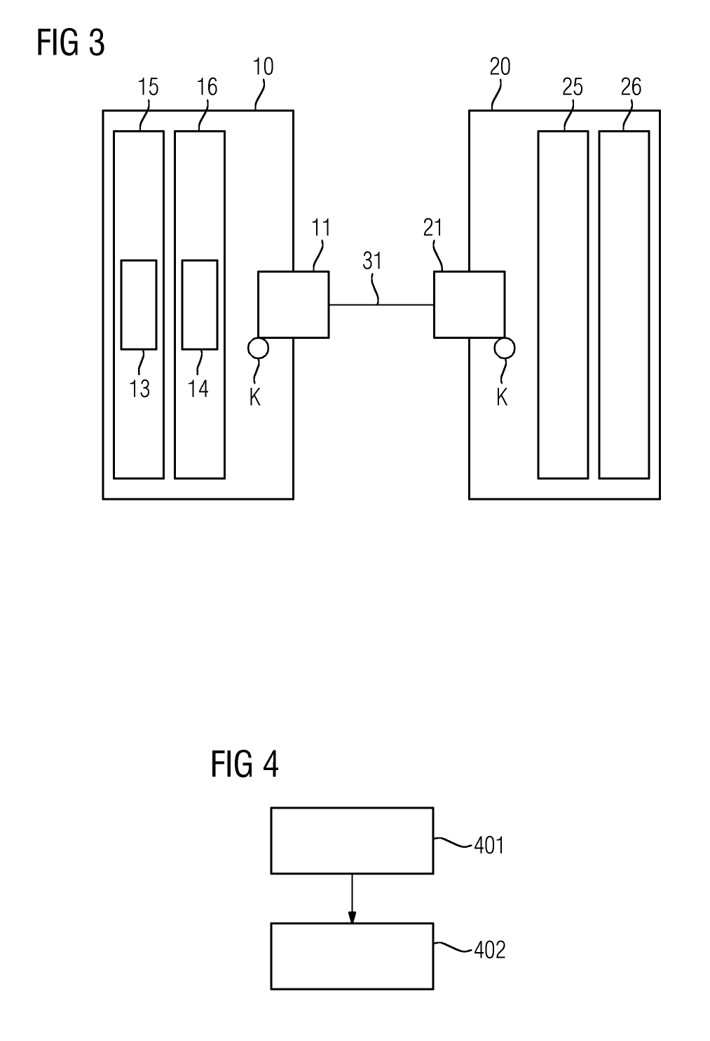

In the figures, elements that are the same or that have the same function have been provided with the same reference symbols unless stated otherwise.

### DETAILED DESCRIPTION

FIG. 4 depicts a flowchart of a first exemplary embodiment of a method for producing cryptographically protected redundant data packets DP′.

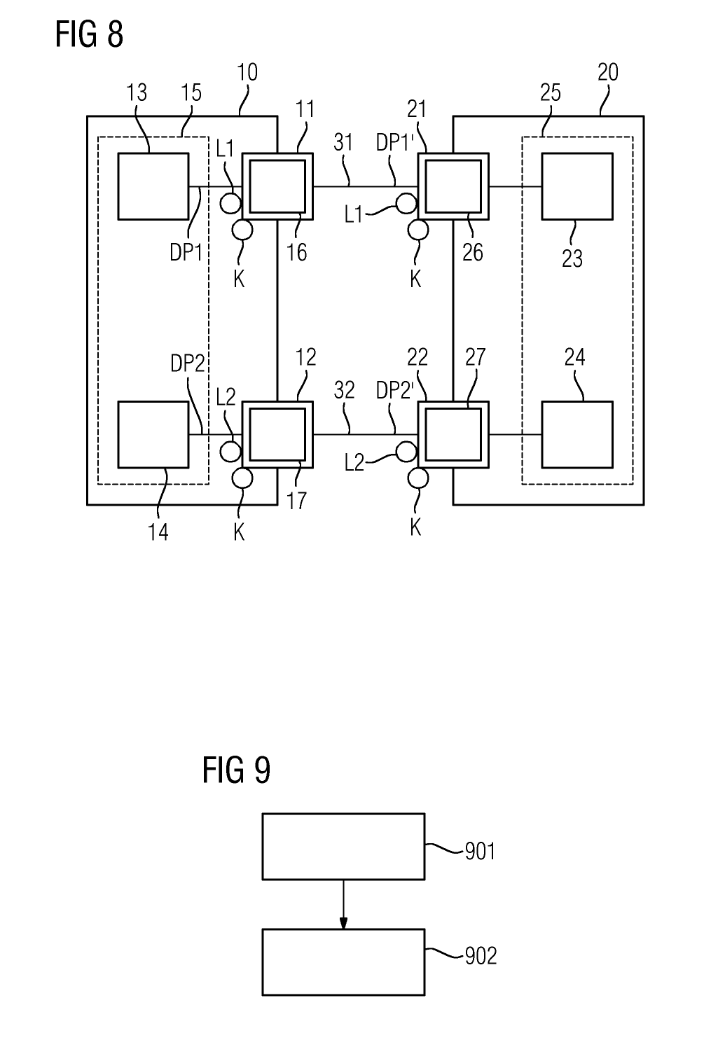

In act 401, N redundant data packets DP are produced by N different production units 13, 14. In this case, the respective production unit 13, 14 has an associated explicit identification 13, 14 (for example, see FIG. 8).

In act 402, N cryptographically protected redundant data packets DP′ are generated from the N produced redundant data packets DP by a single cryptographic function F, wherein the cryptographic function F for the generation of the respective cryptographically protected data packet DP′ is parameterized using a cryptographic key K and the identification L1, L2 associated with the corresponding production unit 13, 14.

In this regard, FIG. 5 depicts a block diagram of a cryptographic function F for producing the cryptographically protected redundant data packets DP′ depicted in FIG. 4. On the input side, the cryptographic function F receives the N redundant data packets DP. The cryptographic function F for the generation of the respective cryptographically protected data packet DP is parameterized using a cryptographic key K and the identification L; L1, L2 associated with the corresponding production unit 13, 14. In addition, the cryptographic function F may also be parameterized using an initialization vector IV. For the example N=2, two production units 13, 14 are provided. Each production unit 13, 14 has an explicit identification L1, L2. By way of example, the first production unit 13 has the identification L1, the second production unit 14 having the identification L2. This distinction allows the cryptographic function F to be parameterized differently for the two.

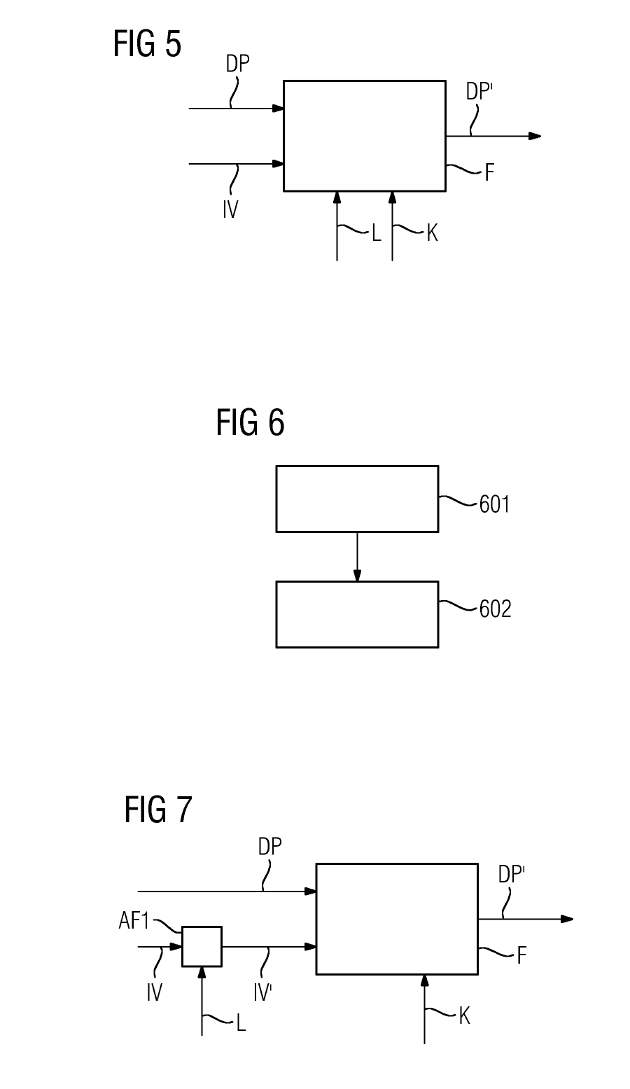

FIG. 6 depicts a flowchart of a second exemplary embodiment of a method for producing cryptographically protected redundant data packets DP′.

In act 601, a number N of redundant data packets DP are provided by N different production units 13, 14. In this case, the respective production unit 13, 14 has an associated explicit identification L; L1, L2.

In act 602, the N cryptographically protected redundant data packets DP′ are generated from the N produced redundant data packets DP by the single cryptographic function F and a single initialization vector IV. The cryptographic function F is parameterized for the generation of the respective cryptographically protected data packet DP′ using the cryptographic key K and an initialization vector IV′ derived from the initialization vector IV by the identification L; L1, L2 associated with the corresponding production unit 13, 14. That is to say that the respective explicit identification L; L1, L2 is used to parameterize the initialization vector IV as appropriate, which provides that the cryptographic function F is parameterized as appropriate.

In this regard, FIG. 7 depicts a block diagram of a cryptographic function F for producing cryptographically protected redundant data packets DP′ as depicted in FIG. 6. In FIG. 7, a first derivation function AF1 is provided. The first derivation function AF1 derives the initialization vector IV by the identification L; L1, L2 associated with the corresponding production unit 13, 14 in order to provide the derived initialization vector IV′.

The respective value of the derived initialization vector IV' may also be formed from a concatenation of an address for a transmitter of the cryptographically protected redundant data packets DP′, the identification L; L1, L2 associated with the corresponding production unit 13, 14 and a current counter value.

In this regard, FIG. 8 depicts a block diagram of a first exemplary embodiment of an arrangement for producing and transmitting cryptographically protected redundant data packets DP1′, DP2′. The arrangement in FIG. 8 has a first network node 10 and a second network node 20. The two network nodes 10 and 20 are coupled to one another by a communication network that is formed by a first communication link 31 and a second communication link 32.

The two network nodes 10, 20 are of the same design, as a result of which the first network node 10, in particular, is discussed below. The network node 10 has a control device 15, which integrates N production units 13, 14. Without restricting generality, N is equal to 2 (N=2) in the figures that follow. By way of example, the control device 15 is in the form of a microcontroller of the network node 10. The control device 15 integrates the two production units 13, 14. The first production unit 13 provides a first data packet DP1. The second production unit 14 provides a second data packet DP2, which is redundant with respect thereto. The respective production unit 13, 14 has an associated explicit identification L1, L2. The respective production unit 13, 14 is coupled to a respective communication interface 11, 12. The first communication interface 11 is coupled to the first communication link 31 and the second communication interface 12 is coupled to the second communication link 32.

The respective communication interface 11, 12 has a respective generation unit 16, 17. The first generation unit 16 of the first communication interface 11 generates a cryptographically protected data packet DP1′ from the first produced data packet DP1 by a cryptographic function F. Correspondingly, the second generation unit 17 generates a cryptographically protected data packet DP2′ from the produced data packet DP2 by the cryptographic function F. The first and second cryptographically protected data packets DP1′ and DP2′ are redundant with respect to one another.

The two generation units 16, 17 are set up to parameterize the single cryptographic function F for the generation of the cryptographically protected data packets DP1′, DP2′ using the cryptographic key K and the identification L1, L2 associated with the corresponding production unit 13, 14. In other words, the first generation unit 16 uses the identification L1 that is associated with the first production unit 13. Similarly, the second generation unit 17 uses the identification L2 that is associated with the second production unit 14. The cryptographically protected redundant data packets DP1′ and DP2′ are transmitted to the network node 20 redundantly, that is to say via the two communication links 31, 32.

FIG. 9 illustrates a flowchart of a third exemplary embodiment of a method for producing cryptographically protected redundant data packets DP′.

In act 901, a number N of redundant data packets DP are provided by N different production units 13, 14. In this case, the respective production unit 13, 14 has an associated explicit identification L; L1, L2.

In act 902, the N cryptographically protected redundant data packets DP′ are generated from the N produced redundant data packets DP by the single cryptographic function F and a single initialization vector IV, wherein the cryptographic function F for the generation of the respective cryptographically protected data packet DP′ is parameterized using a cryptographic key K′, which is derived from the cryptographic key K by the identification L; L1, L2 associated with the corresponding production unit 13, 14, and the initialization vector IV.

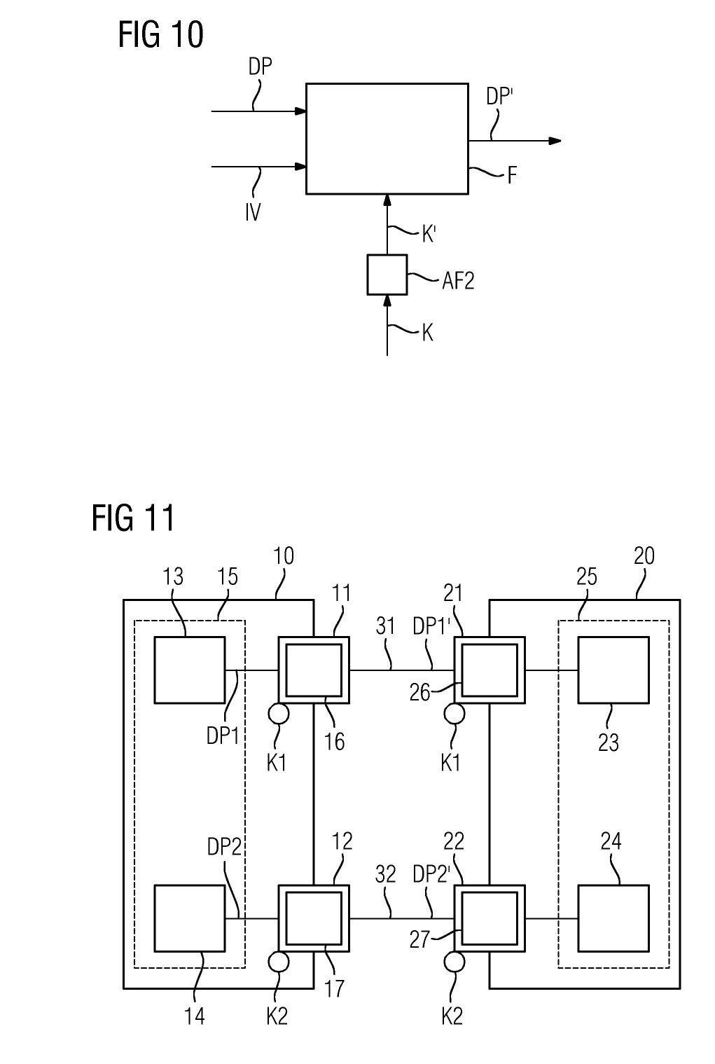

In this regard, FIG. 10 depicts a block diagram of the cryptographic function F for producing the cryptographically protected redundant data packets DP′ as depicted in FIG. 9. In the exemplary embodiment in FIG. 10, a second derivation function AF2 derives cryptographic keys K′ from the single cryptographic key K by the respective identification L.

In a further variant, the embodiments of FIGS. 7 and 10 may be combined such that both the first derivation function AF1 for deriving the initialization vector IV and the second derivation function AF2 for deriving the cryptographic key K are used.

An example of key derivation in an arrangement for producing and transmitting cryptographically protected redundant data packets DP1′, DP2′ is depicted by FIG. 11. The exemplary embodiment of FIG. 11 differs from the exemplary embodiment of FIG. 8 in that in FIG. 11 the initialization vector is not used for parameterizing the cryptographic function but rather keys K1 and K2 derived from the cryptographic key K are used for parameterizing and hence differentiating the cryptographic function F.

In other words, the generation unit 16 in FIG. 11 is configured to parameterize the cryptographic function F for the generation of the cryptographically protected data packet DP1′ using a cryptographic key K1, which is derived from the cryptographic key K by the identification L1, and the single initialization vector IV. By contrast, the second generation unit 17 is configured to parameterize the single cryptographic function F for the generation of the second cryptographically protected data packet DP2′ using a cryptographic key K2, which is derived from the cryptographic key K by the identification L2, and the initialization vector IV.

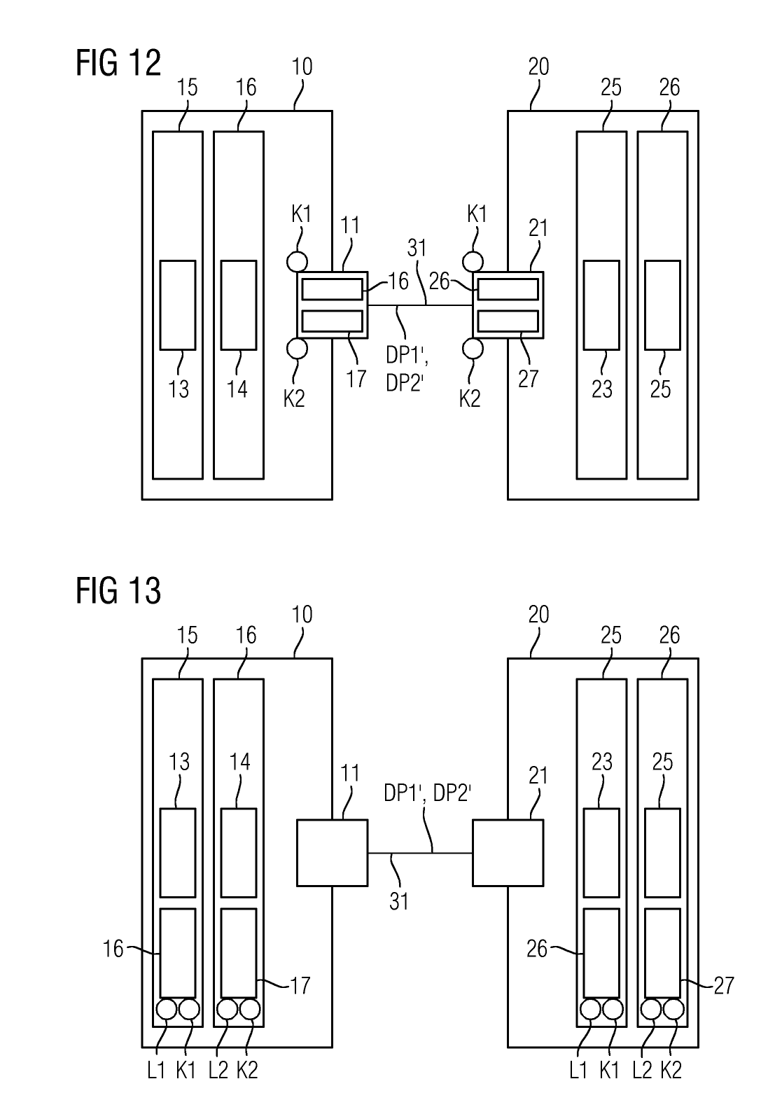

FIG. 12 depicts a block diagram of a third exemplary embodiment of an arrangement for producing and transmitting cryptographically protected redundant data packets DP1′, DP2′.

The exemplary embodiment of FIG. 12 differs from the exemplary embodiment of FIG. 11 in that the respective network node 10, 20 does not have two communication interfaces 11, 12; 21, 22 but rather has just a single communication interface 11, 21. The respective communication interface, for example the communication interface 11 of the network node 10, then integrates the two generation units 16, 17. The two cryptographically protected redundant data packets DP1′, DP2′ are transmitted between the two network nodes 10, 20 via the single communication link 31.

FIG. 13 depicts a block diagram of a fourth exemplary embodiment of an arrangement for producing and transmitting cryptographically protected redundant data packets DP1′, DP2′.

The exemplary embodiment of FIG. 13 differs from the embodiment of FIG. 12 in that the respective generation unit 16, 17 is integrated not in the communication interface 11 but rather in the control device 15, 16, in which the corresponding production unit 13, 14 is also integrated. In this exemplary embodiment, the respective identification L1, L2 has both the production unit 13, 14 and the generation unit 16, 17 associated with it. Accordingly, the identification L1 has both the first production unit 13 and the first generation unit 16 associated with it. Correspondingly, the identification L2 has the second production unit 14 and the second generation unit 17 associated with it.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for producing cryptographically protected redundant data packets comprising:
producing a number N of redundant data packets by N different production units, wherein the respective production unit comprises an associated explicit identification, and
generating N cryptographically protected redundant data packets from the N produced redundant data packets by a single cryptographic function,
wherein the cryptographic function for the generation of the respective cryptographically protected data packet is parameterized using a cryptographic key and the identification associated with the corresponding production unit.

2. The method as claimed in claim 1, wherein the N cryptographically protected redundant data packets are generated from the N produced redundant data packets by the single cryptographic function and a single initialization vector,
wherein the cryptographic function for the generation of the respective cryptographically protected data packet is parameterized using the cryptographic key and an initialization vector derived from the initialization vector by the identification associated with the corresponding production unit.

3. The method as claimed in claim 2, wherein the respective derived initialization vector is derived from the initialization vector by a first derivation function parameterized using the associated identification.

4. The method as claimed in claim 2, wherein the respective value of the derived initialization vector is formed from a concatenation of an address for a transmitter of the cryptographically protected redundant data packets, the identification associated with the corresponding production unit, and a current counter value.

5. The method as claimed in claim 1, wherein the N cryptographically protected redundant data packets are generated from the N produced redundant data packets by the single cryptographic function and a single initialization vector,
wherein the cryptographic function for the generation of the respective cryptographically protected data packet is parameterized using a cryptographic key, which is derived from the cryptographic key by the identification associated with the corresponding production unit, and the initialization vector.

6. The method as claimed in claim 5, wherein the respective derived cryptographic key is derived from the cryptographic key by of a second derivation function parameterized using the associated identification.

7. The method as claimed in claim 1, wherein the N cryptographically protected redundant data packets are generated from the N produced redundant data packets by the single cryptographic function and a single initialization vector,
wherein the cryptographic function for the generation of the respective cryptographically protected data packet is parameterized using a cryptographic key, which is derived from the cryptographic key by the identification associated with the corresponding production unit, and an initialization vector that is derived from the initialization vector by the identification associated with the corresponding production unit.

8. The method as claimed in claim 7, wherein the respective derived initialization vector is derived from the initialization vector by a first derivation function parameterized using the associated identification, and the respective derived cryptographic key is derived from the cryptographic key by a second derivation function parameterized using the associated identification.

9. The method as claimed in claim 7, wherein the respective value of the derived initialization vector is formed from a concatenation of an address for a transmitter of the cryptographically protected redundant data packets, the identification associated with the corresponding production unit, and a current counter value.

10. An apparatus comprising:
at least one processor; and
at least one memory including computer program code for one or more programs;
the at least one memory and the computer program code configured to, with the at least one processor, cause the apparatus to at least perform:
produce a number N of redundant data packets by N different production units, wherein the respective production unit comprises an associated explicit identification, and
generating N cryptographically protected redundant data packets from the N produced redundant data packets by a single cryptographic function,
wherein the cryptographic function for the generation of the respective cryptographically protected data packet is parameterized using a cryptographic key and the identification associated with the corresponding production unit.

11. An apparatus for producing cryptographically protected redundant data packets, the apparatus comprising:
a number N of production units for producing N redundant data packets, wherein the respective production unit comprises an associated explicit identification; and
a number N of generation units for generating N cryptographically protected redundant data packets from the N produced redundant data packets by a single cryptographic function,
wherein the respective generation unit is configured to parameterize the cryptographic function for the generation of the respective cryptographically protected data packet using a cryptographic key and the identification associated with the corresponding production unit.

12. The apparatus as claimed in claim 11, wherein the apparatus is in the form of a communication node in a communication network,
wherein the communication node comprises at least one control device and at least one communication interface coupled to the communication network.

13. The apparatus as claimed in claim 12, wherein the control device integrates the N production units and the communication interface integrates the N generation units.

14. The apparatus as claimed in claim 12, wherein the control device integrates the N production units and the N generation units.

15. An arrangement for a communication network, comprising:
a plurality of communication nodes that are coupled via the communication network, wherein the respective communication node comprises an apparatus for producing cryptographically protected redundant data packets, wherein the apparatus comprises:
a number N of production units for producing N redundant data packets, wherein the respective production unit comprises an associated explicit identification; and
a number N of generation units for generating N cryptographically protected redundant data packets from the N produced redundant data packets by a single cryptographic function,
wherein the respective generation unit is configured to parameterize the cryptographic function for the generation of the respective cryptographically protected data packet using a cryptographic key and the identification associated with the corresponding production unit.

16. The arrangement as claimed in claim 15, wherein the communication node comprises at least one control device and at least one communication interface coupled to the communication network.

17. The arrangement as claimed in claim 16, wherein the control device integrates the N production units and the communication interface integrates the N generation units.

18. The arrangement as claimed in claim 16, wherein the control device integrates the N production units and the N generation units.

19. The method as claimed in claim 3, wherein the respective value of the derived initialization vector is formed from a concatenation of an address for a transmitter of the cryptographically protected redundant data packets, the identification associated with the corresponding production unit, and a current counter value.

20. The method as claimed in claim 8, wherein the respective value of the derived initialization vector is formed from a concatenation of an address for a transmitter of the cryptographically protected redundant data packets, the identification associated with the corresponding production unit, and a current counter value.
